(19) United States
(12) Patent Application Publication
(10) Pub. No.: US 2012/0242792 A1
(43) Pub. Date: Sep. 27, 2012

(54) METHOD AND APPARATUS FOR DISTINGUISHING A 3D IMAGE FROM A 2D IMAGE AND FOR IDENTIFYING THE PRESENCE OF A 3D IMAGE FORMAT BY IMAGE DIFFERENCE DETERMINATION

(76) Inventor: Tao Zhang, Plainsboro, NJ (US)

(21) Appl. No.: 13/514,681

(22) PCT Filed: Dec. 9, 2009
(86) PCT No.: PCT/US09/06469

§ 371 Date: Jun. 8, 2012

(30) Foreign Application Priority Data
Dec. 14, 2009 (FR) 0958962

(51) Int. Cl. H04N 13/00

(52) U.S. Cl. 348/43; 348/E13.06

(57) ABSTRACT

A method identifies the presence of a three-dimensional (3D) image format in received image through the use of image difference determination. The received image is sampled using a candidate 3D format to generate two sub-images from the received image. When the candidate 3D format is a non-blended 3D format, these sub-images are compared to determine whether these sub-images are similar with respect to structure. If the sub-images are not similar, a new 3D format is selected and the method is repeated. If the sub-images are similar, an image difference is computed between the two sub-images to form an edge map. Thicknesses are computed for the edges in the edge map. The thickness and uniformity distribution of the edges are then used to determine whether the format is 2D or 3D and, if 3D, which of the 3D formats was used for the received image.

### CROSS-REFERENCE TO RELATED APPLICATION

This invention is related to a U.S. Patent Application Attorney Docket No. PU090183 entitled “Method For Distinguishing A 3D Image From A 2D Image And For Identifying The Presence Of A 3D Image Format By Feature Correspondence Determination”, filed concurrently herewith and commonly assigned to the same assignee hereof, which is incorporated by reference in its entirety.

### FIELD OF THE INVENTION

This invention relates to a method for identifying a three-dimensional (3D) image and, more particularly, for identifying a format associated with the 3D image wherein the identification is performed using an image difference determination.

### BACKGROUND OF THE INVENTION

Three-dimensional (3D) images exist today in many different digital formats. The number of different formats together with the apparent lack of standardization for formatting such 3D images leads to many problems and further complexities in recognizing the presence of such 3D images and then in determining how the 3D image is formatted in order to process and display the image properly.

Generally 3D contents include a pair of images or views initially generated as separate stereo images (or views). It will be appreciated that the terms “stereo images” and “stereo views” and the terms “images” and “views” may each be used interchangeably without loss of meaning and without any intended limitation. Each of these images may be encoded. In order to store or distribute or display the 3D image, the contents of the two stereo images are combined into a single image frame. So each frame will represent the entire 3D image instead of using two separate stereo images, each in their own frame or file. Various formats for such a 3D image frame are depicted simplistically along the top row of FIG. 1.

As seen from FIG. 1, many 3D image frame formats exist today and it is expected that additional formats will be suggested in the future. Some 3D image frame formats include a side-by-side format, a checkerboard pattern format, an interlaced format, a top-bottom format, and a color based format such as an anaglyph. All but the color based format are shown in simplified form in FIG. 1. In this figure, one of the stereo images or stereo views of a 3D image is depicted in light shading, while the second image or view associated with that 3D image is depicted in dark shading. The ability to support multiple frame formats for 3D images will be important for the success of 3D products in the marketplace.

One problem that arises by generating 3D image files in these single frame formats is that the resulting single image frame without further analysis may appear similar to an image frame used for a non-stereo image or a two-dimensional (2D) image. Moreover, a stream of such 3D image frames may initially appear indiscernible from a stream of 2D image frames. When the format and dimensionality of the image frame is not known or communicated, significant and as yet unsolved problems arise for image viewers, video players, set-top boxes, and the like, which are used for receiving, processing, and displaying the contents of the image frame stream.

Nowhere has the prior art in this technical field shown an ability to distinguish a single stereo image in 3D formats from a non-stereo single image. Moreover, the prior art in this technical field has similarly failed to show an ability to identify that an image file is in one particular format out of a plurality of possible 3D and 2D formats.

### SUMMARY OF THE INVENTION

These and other shortcomings in the prior art are addressed by the present inventive method by identifying the presence of a three-dimensional (3D) image format for a received image through the use of image difference determination. In one embodiment, the received image is sampled using a candidate 3D format to generate two sub-images from the received image. When the candidate 3D format is a non-blended 3D format, these sub-images are compared to determine whether these sub-images are similar with respect to structure. If the sub-images are not similar, a new 3D format is selected and the method is repeated. If the sub-images are found to be similar or if the candidate 3D format is a blended 3D format, an image difference is computed between the two sub-images to form an edge map.

Thicknesses are computed for the edges in the edge map. The thickness and uniformity distribution of the edges are then used to determine whether the format is 2D or 3D and, if 3D, which of the 3D formats was used for the received image. When the format of the received image is determined, that format can be used to process and display the received image.

### BRIEF DESCRIPTION OF THE DRAWINGS

The teachings of the present invention can be readily understood by considering the following detailed description in conjunction with the accompanying drawings, in which:

FIG. 1 depicts a plurality of exemplary 3D image formats;

FIG. 2 depicts a flow chart of a method for use in identifying the existence of a particular blended 3D image format, when present in an image under test, in accordance with an embodiment of the present invention;

FIG. 3 depicts a flow chart of a method for use in identifying the existence of a particular non-blended 3D image format, when present in an image frame under test, in accordance with an embodiment of the present invention; and

FIG. 4 depicts a high level block diagram of an embodiment of a processing unit suitable for executing the inventive methods and processes of the various embodiments of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method for identifying a three-dimensional (3D) image and, more particularly, for identifying a format associated with the 3D image wherein the identification is performed using an image difference determination. Although the present invention may be described primarily within the context of a video decoder and display environment, the specific embodiments of the present invention should not be treated as limiting the scope of the invention. It will be appreciated by those skilled in the art and informed by the teachings of the present invention that the concepts of the present invention can be advantageously applied in substantially any video-based environment such as, but not limited to, television, transcoding, video players, image viewers, set-top-box, or any software-based and/or hardware-based implementations to identify 3D formats.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

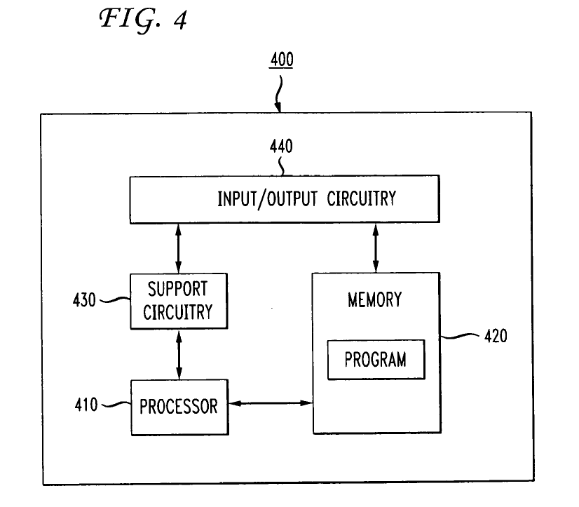

For example, FIG. 4 depicts a high level block diagram of an embodiment of a processing unit 400 suitable for executing the inventive methods and processes of the various embodiments of the present invention. More specifically, the processing unit 400 of FIG. 4 illustratively comprises a processor 410 as well as a memory 420 for storing control programs, algorithms, stored media and the like. The processor 410 cooperates with conventional support circuitry 430 such as power supplies, clock circuits, cache memory and the like as well as circuits that assist in executing the software routines stored in the memory 420. As such, it is contemplated that some of the process steps discussed herein as software processes may be implemented within hardware, for example, as circuitry that cooperates with the processor 410 to perform various steps. The processing unit 410 also contains input-output circuitry 440 that forms an interface between various functional elements communicating with the processing unit 410 such as displays and the like.

Again, although the processing unit 400 of FIG. 4 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software, hardware, or a combination thereof.

As such, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudo-code, and the like represent various processes which may be substantially represented in computer readable media and so executed by a computer or processor, whether or not such computer or processor is explicitly shown herein.

In accordance with embodiments of the present invention, a method has been developed to determine whether an image is in a 3D format or even whether the image is 3D at all based on the use of image difference information generated from the image. Moreover, the method is capable of identifying which one of the plurality of 3D formats is exhibited by the image, when it has been determined that the image is a 3D image rather than a 2D image. It is understood that a single image in 3D format contains information from two similar, but different, images or views. These two images actually differ significantly because the images are taken from different points of reference and different viewing angles. In contrast, a single 2D image contains information from only a single reference point and viewing angle, therefore, from only a single view. It has been determined herein that these differences can be exploited to show whether the image is or is not in a 3D format. Moreover, it is then possible to determine which particular 3D format has been applied to the image.

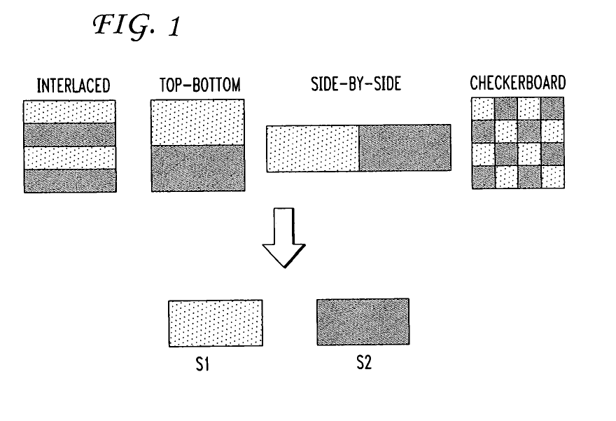

FIG. 1 depicts a variety of different 3D formats across the top row. The formats shown include an interlaced format, a top-bottom (also known as over-under) format, a side-by-side format, and a checkerboard pattern format. The interlaced format shown is for horizontal interlacing. It will be appreciated that the orthogonal format to horizontal interlacing, namely, vertical interlacing could be achieved by interlacing alternating columns from each image or view instead of the alternating rows. The formats shown in this figure represent an exemplary listing rather than an exhaustive listing of all known 3D formats. In FIG. 1, one of the stereo images or stereo views (S₁) of a 3D image is depicted in light shading, while the second image or view (S₂) associated with that 3D image is depicted in dark shading.

As shown in FIG. 1, when the images at the top of FIG. 1 are processed properly according to their respective formats, it is possible to extract the individual stereo images or views, S₁ and S₂, from the single 3D image at the top. This processing is called sampling later in this application. These separate views can then be applied to a video processor and display for generating the original 3D picture or frame for viewing by a user. It will be appreciated that the resolution of each image S₁ and S₂ is no more than half the resolution of the entire original 3D image. The terminology of image or view with respect to the entity S₁ or S₂ is intended to be equivalent without any limitation or loss of generality.

The 3D formats in FIG. 1 can be classified into two groups according to the degree of blending at a pixel level between the left and right views, S₁ and S₂. One group includes the blended 3D formats while the other group includes the non-blended 3D formats. For blended 3D formats, each pixel tends to be surrounded by pixels from both the left and right views. Examples of blended 3D formats are the interlaced (horizontal or vertical) and checkerboard pattern formats. For non-blended 3D formats, each pixel tends to be surrounded by pixels from the same view with the exception of pixels at view boundaries as can be seen for the pixels at the S₁/S₂ boundary in the side-by-side and over-under formats. Side-by-side, over-under, and color based formats are included in the group of non-blended 3D formats. The color-based format such as a format employing anaglyphs is not shown in FIG. 1 and it will not be described further herein since it is well known in the art.

In the description that follows, an explanation is given about distinguishing images in 3D formats from images in a 2D format in accordance with embodiments of the present invention. Examples are provided for each group of formats together with a presentation for a mixture of the two groups of formats.

Initially, it is assumed a received image is sampled to generate two separate images, S₁ and S₂, as shown in FIG. 1. Additionally, it is assumed that the sampling techniques that are being used include techniques for the blended 3D formats. Finally, it is assumed that the received single image is in fact a 2D image. If the received image is sampled to generate two separate images, S₁ and S₂, these two images will be almost identical in both content and depth. Any slight differences between the images S₁ and S₂ are caused by a very small uniform displacement due to the sampling. A simple image subtraction between these two images will produce an edge map that shows a so-called “edge” to indicate where an image difference occurs. When the received image is a 2D image and S₁ and S₂ are extracted using a blended 3D format technique, the edges in this edge map are thin with substantially uniform thickness. This results from using an image extraction based on a blended 3D format. For example, in the horizontal interlaced 3D format, extraction may be performed by placing the odd numbered image rows of pixels from the received image into S₁ while placing the even numbered image rows of pixels from the received image into S₂. Since the received image was assumed to be 2D, such a blended 3D extraction technique would invariably create two almost identical images S₁ and S₂ since their corresponding rows would be displaced by only one pixel from each other. Since the images are substantially identical, it follows that a subtraction of the images will produce either no difference at all or a slight difference that will show up as sparse edges or thin edges. The thickness of edges in such an example would be expected to be at most several pixels wide.

When a received image is in a blended 3D format, denoted as F, if the image is sampled to generate two images and if an image difference is computed from these two images S₁ and S₂, the resulting image, E, can be quite different depending on which sampling method is used to extract S₁ and S₂. For example, if the corresponding sampling method corresponding exactly to format F is used to extract S₁ and S₂, the image, E, from the image difference step will be an edge map having edges whose thicknesses are not uniform and which exhibit large differences. This is so because the image extraction results in the correct S₁ and S₂ being generated wherein S₁ and S₂ are different views, by depth and point of reference, for example, for the same image. On the other hand, if sampling methods are employed that do not correspond to format F, the image, E, resulting from the difference of S₁ and S₂ can be expected to be an edge map exhibiting uniform edge thickness in a manner quite similar to that shown for a 2D image. Thus, by using the methodology of the present invention as described above, it is possible to determine whether a received image is a single 2D image or a single 3D image and, if the latter, whether it corresponds to a particular blended 3D format.

Again, it is assumed that a received image is sampled to generate two separate images, S₁ and S₂, as shown in FIG. 1. But this time, it is assumed that the sampling techniques that are being used include techniques for the non-blended 3D formats. Then, it is assumed that the received single image is in fact a 2D image. If the received image is sampled to generate two separate images, S₁ and S₂, these two images will be different in structure because the images are taken from disparate parts of the 2D image. So when the received image is a 2D image and S₁ and S₂ are extracted using a non-blended 3D format technique, it is expected that a similarity of the images will reject the tested sampling method and its corresponding 3D non-blended format.

When the received image is in a non-blended 3D format denoted by F and the images S₁ and S₂ are produced using the non-blended 3D format F, the resulting image E may again be quite different depending on which non-blended 3D sampling method is used. If we use the sampling methods designed for the format F, image E will be an edge map exhibiting non-uniform edge thickness. On the other hand, if the sampling method is one that was not designed for format F, image E is not an edge map at all since the two images sampled S₁ and S₂ are totally different. Thus, by using the methodology described immediately above, it is possible to determine whether a received image is a single 2D image or a single 3D image and, if the latter, whether it corresponds to a particular non-blended 3D format.

From the above description, it is understood that the resulting edge E map exhibits a non-uniform edge thickness for an image in a 3D format F, whether blended or non-blended, only if the image is sampled using a sampling method designed for and corresponding to the format F. Otherwise, it is understood that the resulting image difference, E, may be an edge map with uniform edge thickness (as in blended 3D formats) or not an edge map at all (as in non-blended 3D formats). So if the 3D formats in consideration include both blended and non-blended 3D formats, it is possible to combine the methods discussed for blended and non-blended 3D formats to determine whether the single 2D image or a single 3D image and, if the latter, whether it corresponds to a particular combined blended and non-blended 3D format.

From the description above, it is understood that similarity testing is performed when for the non-blended 3D format based method. Similarity testing could be performed for the blended 3D format based technique since most sampling techniques on images formatted using a blended 3D format will extract two similar images. However, there is a possibility that, under certain conditions, a blended 3D formatted image could be processed in such a way that the two extracted views S₁ and S₂ are determined to be dissimilar. Thus, the image would be improperly rejected from further processing. So it would be preferable to perform similarity testing only for views from a non-blended 3D format sampling technique in order to avoid the problem of an improper rejection.

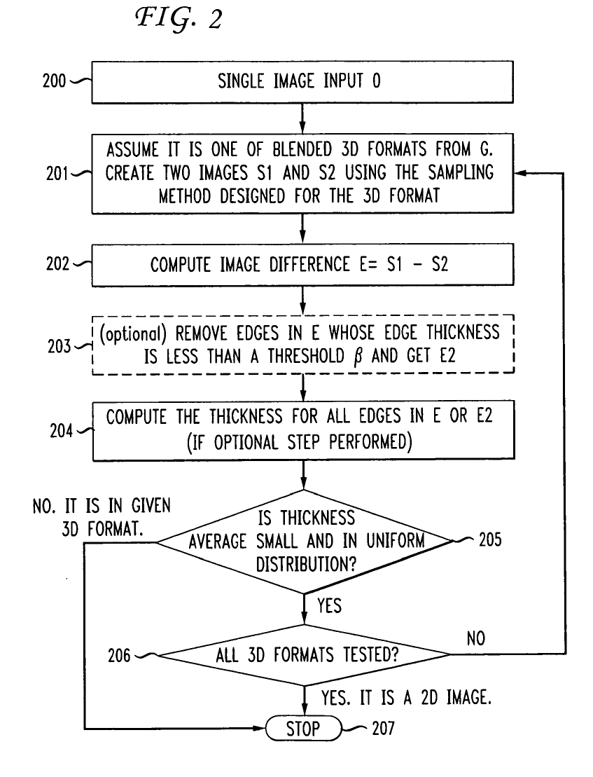

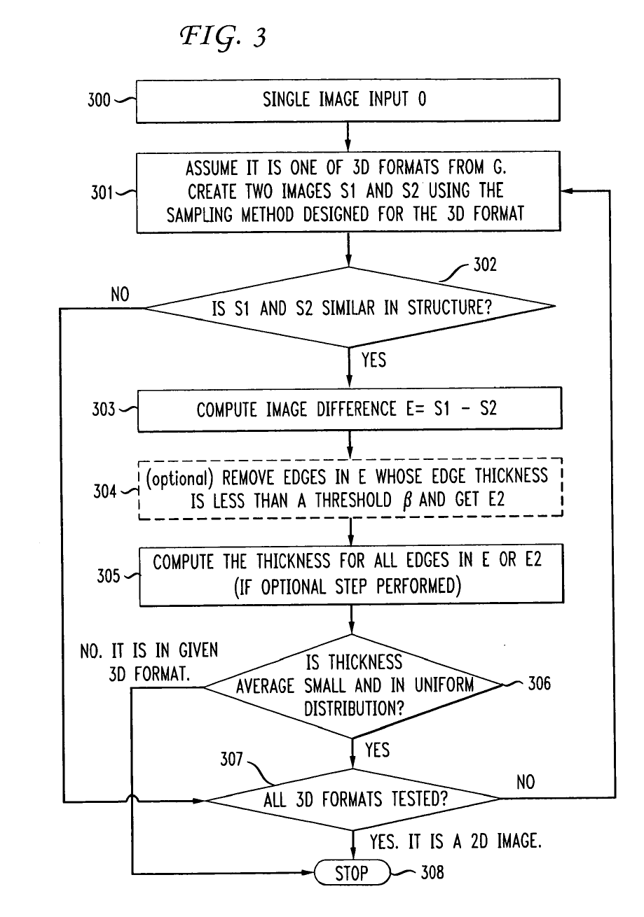

Below, example presentations of the technique described above will be made in more detail below with respect to FIGS. 2 and 3. The method related to blended 3D formats is shown in FIG. 2, whereas the method related to non-blended 3D formats is shown in FIG. 3.

The nomenclature used in the following description is described below. It is assumed that there are candidate 3D formats and that, if the image being reviewed is in a particular 3D format, the particular 3D format is from the candidate 3D formats. It should be understood that new 3D formats—that is, formats not currently in the group of candidate 3D formats—can be supported easily by adding them to this group of candidate formats and by including the sampling method properly designed for and corresponding to them. G is defined to be a group of 3D formats and their corresponding sampling methods, so that

G={(G₁, M₁), (G₂, M₂), . . . , (G_{NF}, M_{NF})},

where Gᵢ is a candidate 3D format, Mᵢ is the sampling method corresponding to candidate 3D format Gᵢ, and NF is the total number of 3D formats supported in the group of candidate formats.

The method for identifying a 3D image and its corresponding format where the format is selected from the group of candidate blended 3D formats is shown in FIG. 2. The method begins in step 200 during which an input is received as a single image input O. The single image input O is expected to be in either a 3D format or in a 2D format. The method then proceeds to step 201.

In step 201, it is assumed that the input image O is formatted according to a candidate 3D format Gᵢ from the group of candidate formats G. Two images S₁ and S₂ are then generated from the input image O according to its predefined corresponding sampling method Mᵢ. It should be understood that the input image or the resulting images S₁ and S₂ can also be subjected to a transformation such as from color to grayscale or the like. The method then proceeds to step 202.

In step 202, the image difference E of S₁ and S₂ is computed. The resulting image is given as edge map E=S₁−S₂. It will be appreciated that the order of subtraction can be varied without any loss of accuracy or generality. So the image difference could also be expressed as edge map E=S₂−S₁. In general, the image difference computation is performed on a pixel-wise basis so that pixels from corresponding locations in the two images S₁ and S₂ are subtracted from each other. It should also be noted that when the image includes one or more channels, the difference computation should be performed within the same channel for each image S₁ and S₂. In this case, a channel can be selected from the group of RGB channels or the group of YUV channels or even among different grayscale levels. The method then proceeds to optional step 203 or, if the optional step is not performed, to step 204.

Image subtraction as shown in the formulas above is considered to be a simple method to compute edge maps between two very similar images. It is also contemplated that this step can be realized by computing two individual edge maps which are then subtracted to form the difference E_{D} of edge maps. One of the individual edge maps is computed for S₁ and is denoted as E_{S1}, the other one of the individual edge maps is computed for S₂ and is denoted as E_{S2}. The edge map difference is then computed as E_{D}=E_{S1}−E_{S2}. It will be understood that E_{D} is the substantial equivalent of E shown in the equations above.

It has been found that direct image subtraction, that is, E=S₁−S₂, in experimental practice is simpler and faster to implement and operate. In most cases, the edge maps show obvious interlaced patterns (e.g., vertical or horizontal) which are relatively easy to filter out in the optional steps such as step 203 or step 304 in methods described herein.

As an optional step for the operation of this method as shown by step 203, it is possible to prune the edge map E by removing any edges having thickness smaller than a certain threshold β. This pruned edge map is denoted as E₂. The threshold is selected to remove any edges or artifacts whose thickness, either vertically or horizontally, is less than β. When the optional step is performed, it has been found from experimental practice that the thresholds discussed below for subsequent steps in the method will be affected. It has been determined that the thresholds should preferably be decreased from those threshold values that would have been used if the optional step 203 was not performed.

While many possibilities exist for the image processing operation(s) of optional step 203, it will be understood that an exemplary technique involves standard mathematical morphological operations such as erosion, dilation, open and close operations, all of which are well known in the image processing arts.

Morphological filtering, including the operations of erosion and then dilation, can be applied to image to eliminate noise and make regions of narrow edges more homogeneous. Morphological filtering is a well-known process for image enhancement that tends to simplify the image and thereby facilitate the search for objects of interest. It generally involves modifying the spatial form or structure of objects within the image. As noted above, dilation and erosion are two fundamental morphological filtering operations. Dilation allows objects to expand, thus potentially filling in small holes and connecting disjoint objects. Erosion is the complementary operation to dilation in that erosion shrinks objects by etching away (eroding) their boundaries. These operations can be customized for each application by the proper selection of a structuring element, which determines exactly how the objects will be dilated or eroded.

In an example from experimental practice, a simple open operation is employed to remove all edges with thickness less than β. If it is determined that a thickness of 3 or less is sufficiently small that it can be removed from edge map E, then β can be set to 3 so that the structure elements can be selected as se₁=[1 1 1 1], a row vector of length 4, and se₂=[1;1;1;1], a column vector of length 4, with length β+1. Using se₁, the morphological operation is performed in a horizontal direction, whereas, using se₂, the morphological operation is performed in a vertical direction. After performing an open operation using se₁ and se₂ sequentially, all edges with horizontal or vertical thickness less than or equal to β of 3 will be removed from E. Operations such as erosion with se₁ and se₂ followed by dilation with se₁ and se₂ could also be employed for such an edge removal.

When optional step 203 is complete, the method then proceeds to step 204.

In step 204, the thickness of each edge is computed over the edge map E or over the optional edge map E₂ from step 203 in the horizontal direction and/or in the vertical direction. The method then proceeds to step 205. It should be understood that it is possible to perform this computation over either the horizontal direction alone or over the vertical direction alone or over a combination of both directions. In an example using the latter case, it is possible to compute a thickness in the vertical direction for lines that are substantially horizontal, that is, the line has an inclination between +45 degrees and −45 degrees. Similar variations of the techniques described above are contemplated herein.

In decision step 205, the distribution of the statistics of thickness in the edge map E or E₂ is analyzed. The distribution of statistics can include the horizontal statistics or the vertical statistics or a combination of both horizontal and vertical statistics. If the average thickness of an edge is small in comparison to a threshold thickness and if the distribution of the thickness is uniform so that there are no large changes in thickness along an edge, the process proceeds to step 206. Otherwise, the process flow is diverted to step 207 since it is determined by the analysis in step 205 that the input image is in a blended 3D format and the format is the currently tested 3D blended format Gᵢ. At step 207, the process stops.

It should be understood that there are a number of well-known techniques capable of analyzing the statistics of edge thickness. One exemplary technique suitable for use herein employs a heuristic threshold, α, where α is measured in pixels. One such exemplary threshold could be α=3 pixels. As mentioned above, this threshold is used while the optional step 203 is performed; otherwise, the threshold α would usually be a larger value since the optional step would not be performed. In this exemplary technique, the maximum value of the absolute value of the thickness expressed as max (abs (thickness)) is compared to the threshold α. If this thickness value is less than or equal to the threshold, then the thickness is determined to be uniform and small, that is the “YES” branch from decision step 205. Otherwise, the thickness is determined to be neither uniform nor small, that is the “NO” branch from decision step 205.

In another example from experimental practice, it is possible to use the mean value and the standard variance of the thickness in step 205. If mean value of the thickness is small and the standard variance is also small, then it is treated as uniform and small, that is the “YES” branch from decision step 205. Otherwise, it is treated as non uniform, that is the “NO” branch from decision step 205. If the optional edge removal step 203 is performed, the mean and standard variance can be set for the present example to values between 1.5-2.0, for example; otherwise, if the optional step is not performed, the mean value will be a larger value such as 4.5-5, for example, when β=3, and the standard variance can be maintained in the range of 1.5-2.0. The term “small” in this context should be understood to mean values that are less than the defined mean and standard variance values.

When control is transferred to decision step 206, the process checks whether all possible candidate 3D blended formats Gᵢ, for i=1, 2, . . . NF, have been tested. If all candidate formats have been tested, it is determined that the input image O is a 2D image and process control is shifted to step 207. If all candidate formats G have not been tested, then process control is shifted to step 201 where a new format Gᵢ is selected for this iteration of the process.

The method for identifying a 3D image and its corresponding format where the format is selected from the group of candidate non-blended 3D formats is shown in FIG. 3. The method begins in step 300 during which an input is received as a single image input O. The single image input O is expected to be in either a 3D format or in a 2D format. The method then proceeds to step 301.

In step 301, it is assumed that the input image O is formatted according to a candidate 3D format Gᵢ from the group of candidate formats G. Two images S₁ and S₂ are then generated from the input image O according to its predefined corresponding sampling method Mᵢ. It should be understood that the input image or the resulting images S₁ and S₂ can also be subjected to a transformation such as from color to grayscale or the like as mentioned above with respect to the method in FIG. 2. The method then proceeds to step 302.

In decision step 302, the method performs image processing operations on images S₁ and S₂ to determine if S₁ and S₂ are different images, that is, not similar images. The concept of being “different images” is understood to mean that S₁ and S₂ are from different parts of a single image and that S₁ and S₂ are totally different in structure. If, in step 302, it is determined that S₁ and S₂ are different in structure, the control is transferred to step 307. Otherwise, the control of the method is transferred to step 303.

Numerous techniques are available to determine if S₁ and S₂ are similar in structure or, conversely, different in structure. While some methods may be complicated for performing this determination, it is understood that simple methods exist.

Two exemplary methods for determining whether the structures are similar or different are described below. In one such technique, feature points in S₁ and S₂ are compared. If most detected features such as point features in S₁ are missing from S₂ upon comparison, a determination can be made that the two images are different in structure. Conversely, if most detected features such as point features in S₁ are found in S₂ upon comparison, a determination can be made that the two images are similar in structure. Another technique uses image differences. If S₁ and S₂ are similar in structure, their image difference E=S₁−S₂, or vice versa, will be minimal and sparse and substantially blank. On the other hand, if S₁ and S₂ are not similar in structure, that is, if they are different, the differences in image E are huge and the resulting image E is dense. So, when the image E is formed in this technique, the sparseness or density of non-blank pixels can be used to make the similarity determination. A ratio of the total number of non-blank pixels to the total number of pixels can be used to show substantial similarity and substantial difference with respect to structure.

For stereo images and videos, it can be assumed without loss of generality that intensity changes between left and right views (i.e., S₁ and S₂) are relatively small. So it is possible to use histogram similarity to characterize the structure similarity for step 302. Although histogram similarity does not always correspond to or identify structure similarity without complete accuracy, it does typically identify image pairs are not similar. Histogram similarity can be measured by a Bhattacharyya measure denoted by B. This measure is also referenced as the Bhattacharyya distance.

The Bhattacharyya measure or Bhattacharyya distance is well known in the field of statistics. The original paper defining this measure was written by A. Bhattacharyya and is entitled “On a Measure of Divergence Between Two Statistical Populations Defined by their Probability Distributions”, published in 1943 in Bull. Calcutta Math. Soc., Vol. 35, pp. 99-110.

In statistics, the Bhattacharyya distance is used to measure the similarity of two discrete probability distributions. It is normally used to measure the separability of classes in classification. For discrete probability distributions p and q over the same domain X, the Bhattacharvva distance can be defined as follows: DB(p,q)=−ln(BC(p,q)), where

$$BC ( p , q ) = {\sum }_{x ∈ X} \sqrt{p ( x ) q ( x )}$$

and where BC(p,q) is the Bhattacharyya coefficient. For continuous distributions, the Bhattacharyya coefficient is usually defined as, BC(p,q)=∫\sqrt{p(x)q(x)}.

In order to show the determination of similarity, it is useful to show a simple example using histograms. In this example, a histogram is computed for an image. For a gray scale image with intensity between 0-255, the intensity range 0-255 is divided into N bins. When a pixel in the image is shown to have a value v, that pixel is identified as belonging to the bin v/N. The quantity in the bin is then incremented by 1. This is repeated for all the pixels in the image to create the actual image histogram. The histogram actually represents the intensity distribution of the image. Two histograms p and q are generated from the two images or views S₁ and S₂. Histogram similarity is then simply a determination of how close or similar these two histograms appear. If the two images are similar, the histogram will be similar. It should be appreciated that similarity in histogram does not always mean structure similarity.

The similarity check in step 302 using the Bhattacharyya measure can be realized as a threshold comparison as follows: if B is less than the threshold, the images are similar in structure; otherwise, the images are not similar in structure. In one example, the threshold has been set to 0.04. This threshold value is defined through experimental practice by trial and error. Other techniques may be useful for determining this threshold. At this time, the threshold value shown above has provided excellent result for substantially all images tested to date.

In step 303, the image difference E of S₁ and S₂ is computed. The resulting image is given as edge map E=S₁−S₂. As before, it will be appreciated that the order of subtraction can be varied without any loss of accuracy or generality. So the image difference could also be expressed as edge map E=S₂−S₁. In general, the image difference computation is performed on a pixel-wise basis so that pixels from corresponding locations in the two images S₁ and S₂ are subtracted from each other. It should also be noted again that when the image includes one or more channels, the difference computation should be performed within the same channel for each image S₁ and S₂. In this case, a channel can be selected from the group of RGB channels or the group of YUV channels or even among different grayscale levels. The method then proceeds either to step 304 when the optional step is performed or to step 305, if the optional step is not performed.

As an optional step for this method as shown by step 304, it is possible to prune the edge map, E, by removing any edges having thickness smaller than a certain threshold β. This pruned edge map is denoted as E₂. The threshold is selected to remove any edges or artifacts whose thickness, either vertically or horizontally, is less than β. While many possibilities exist for the image processing operation(s) of optional step 304, it will be understood that an exemplary technique involves standard mathematical morphological operations such as erosion, dilation, open and close operations, all of which are well known in the image processing arts. These techniques have already been discussed above with respect to the similar step 203 in the method of FIG. 2. The method then proceeds to step 305.

In step 305, the thickness of each edge is computed over the edge map, E, or over the optional edge map E₂ from step 304 in the horizontal direction and/or in the vertical direction. The techniques employed in this step can be similar to those used in step 204 as described above. The method then proceeds to step 306.

In decision step 306, the distribution of the statistics of thickness in the edge map, E or E₂, is analyzed in a manner similar to that shown and described in FIG. 2, step 205. If the average thickness of an edge is small in comparison to a threshold thickness and if the distribution of the thickness is uniform so that there are no large changes in thickness along an edge, the process proceeds to decision step 307. Otherwise, the process flow is diverted to step 308 since it is determined by the analysis in step 306 that the input image is in a non-blended 3D format and the format is the currently tested 3D non-blended format Gᵢ. At step 308, the process stops.

When control is transferred to step 307, the process checks whether all possible candidate 3D non-blended formats Gᵢ, for i=1, 2, . . . NF, have been tested. If all candidate formats have been tested, it is determined that the input image O is a 2D image and process control is shifted to step 308. If all candidate non-blended formats G have not been tested, then process control is shifted to step 301 where a new non-blended format Gᵢ is selected for the next iteration of the process.

The method for identifying a 3D image and its corresponding format where the format is selected from the group of candidate formats that are representative of mixed blended and non-blended 3D formats is identical to the process shown in FIG. 3 and described above with respect to non-blended 3D formats.

Each of the blended and non-blended formats, as well as the mixed formats mentioned above, requires a sampling technique that is specific to the format so that the two images can be extracted properly. FIG. 1 shows how to generate two images from a single image in different 3D formats. The sampling methods are straightforward and well known in the art.

For example, in the horizontal interlaced format, the corresponding sampling method extracts one line (i.e., horizontal row of pixels) for image S₁ and then the next line for S₂, iteratively. The order of the lines from the original single image is maintained in creating the two images S₁ and S₂. In an alternative realization of this sampling technique, it is contemplated that the lines are grouped in pairs so that two consecutive lines are extracted for S₁ and then the next two consecutive lines are extracted for image S₂. Other alternative realizations are contemplated for this sampling technique.

For the vertical interlaced format, the corresponding sampling method extracts one line (i.e., vertical column of pixels) for image S₁ and then the next line for S₂, iteratively. The order of the lines from the original single image is maintained in creating the two images S₁ and S₂. Alternative realizations are contemplated for this sampling technique in a manner similar to the alternatives mentioned for the horizontal interlaced technique.

For the checkerboard pattern format, the corresponding sampling technique extracts the odd pixels from the odd rows together with the even pixels from the even rows for image S₁ while it also extracts the even pixels from the odd rows together with the odd pixels from the even rows for image S₂. In alternate embodiments of the present invention, this technique could be realized to extract alternating groups of pixels instead of individual pixels.

Sampling for the non-blended 3D formats is simpler in that the sampler merely separates S₁ and S₂ at their interface in the single image. For example, S₁ can be taken from the left side (half) of the single image while S₂ is taken from the right side (half) of the single image for the side-by-side format. A similar approach can be taken for sampling the top-bottom format.

Sampling, as discussed above, is performed in such a manner that the resulting image or view S₁ contains only pixels from one view and image S₂ contains pixels from the other view. It is contemplated also that sampling is performed on the same channel such as the Y channel in a YUV file or the G channel in an RGB file. As described herein, the method for identifying the 3D formats employs image difference and is therefore an intensity based method. This makes the method relatively sensitive to intensity changes. Unless other algorithms are utilized to effectively compensate intensity changes on different channels, the same channels should be used in sampling. It is expected that sampling from different channels generally will result in substandard results.

The image difference based methods described herein have been shown as individual methods in FIGS. 2 and 3. It should be understood that these two methods can be performed individually or sequentially. That is, the blended 3D format method may be performed on the single image and/or the non-blended 3D format method may be performed on the single image. Also, the blended and non-blended 3D format methods may be performed together so that one set of formats is tested before the other set of formats. In this embodiment, it has been found preferable to test blended formats before the non-blended formats. It should also been contemplated that yet another embodiment of the methods allows for batch processing rather than iterative processing so that the statistics for all the 3D formats are computed at the same time. In this latter embodiment, the method decisions (e.g., 3D vs. 2D and particular 3D format) can be determined on all the statistics computed.

In the co-pending related patent application identified above, the method disclosed employs a technique relying on feature correspondence. This technique is fundamentally different from the techniques described herein that rely on image difference. Feature correspondence based methods detect features and establish a one-by-one correspondence between detected features. In contrast, image difference based methods do not rely on features for proper operation.

It should be understood that, while the difference operations to compute the edge maps involve simple subtraction, it has been contemplated that the edge maps could also be computed using absolute value differences. For example, the relationships described above could alternatively be described as E=|S₁−S₂| or E=|S₂−S₁| or E_{D}=|E_{S1}−E_{S2}|.

In the operation of the methods described herein, it has been noted that the image difference is computed preferably pixel-wise and on the same channel. It is further contemplated that the image difference could be computed for one or more or even all channels in the image. For example, one image difference could be computed for the Y channel, while another could be computed for a U channel, while yet another could be computed for the V channel, all within a single iteration of the method for a particular 3D format. These image differences would then be recomputed as the candidate 3D format is changed. While YUV channels have been discussed above, this technique could be applied similarly to RGB channels and even to grayscale levels (channels).

Having described various embodiments for a method for the identifying 3D image formats (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method for identifying the presence of a three-dimensional (3D) image format in a received image, the method comprising:
generating first and second sub-images from the received image using a sampling method corresponding to a candidate 3D format selected from a plurality of 3D formats;
computing an image difference between the first and second sub-images to generate an edge map having a plurality of edges; and
computing a thickness for each edge in the plurality of edges;
wherein, if the thicknesses for the plurality of edges are uniformly distributed and less than or equal to a threshold, determining whether each 3D format of the plurality of 3D formats has been selected as a candidate 3D format; and
if all 3D formats in the plurality of 3D formats have been selected, identifying the received image as a two-dimensional (2D) format; and
if all 3D formats in the plurality of 3D formats have not been selected, selecting as the candidate 3D format a 3D format not previously selected from the plurality of 3D formats and repeating the generating and computing steps using the not previously selected 3D format; and
wherein, if the thicknesses for the plurality of edges are not uniformly distributed or are greater than said threshold, identifying the received image as being formatted in a candidate 3D format used to make such determination.

2. The method as defined in claim 1 further comprising determining a distribution of thicknesses for the plurality of edges in said edge map and comparing the thickness of each edge to said threshold.

3. The method as defined in claim 1 wherein said plurality of 3D formats include blended 3D formats.

4. The method as defined in claim 1 wherein said computing to generate an edge map comprises computing a first image edge map of said first sub-image, computing a second image edge map of said second sub-image, and computing said image difference between said first image edge map and said second image edge map to generate said edge map having said plurality of edges.

5. The method as defined in claim 1 further including processing for display said received image according to the identified format.

6. The method as defined in claim 1 wherein said generating first and second sub-images further comprises filtering each of the first and second sub-images to be in a single channel of a plurality of channels so that said single channel of said first sub-image is identical to said single channel of said second sub-image.

7. The method as defined in claim 1 wherein said computing said image difference further includes removing each edge in said edge map whose thickness is less than a filtering threshold.

8. The method as defined in claim 7 wherein said removing includes one or more morphological filtering operations selected from the group of erosion, dilation, open and close operations.

9. A method for identifying the presence of a three-dimensional (3D) image format in a received image, the method comprising:
generating first and second sub-images from the received image using a sampling method corresponding to a candidate 3D format selected from a plurality of 3D formats;
comparing said first and second sub-images to determine whether the first and second sub-images are similar with respect to structure;
wherein, if the first and second sub-images are determined not to be similar in structure, determining whether the each 3D format of plurality of 3D formats has been selected as a candidate 3D format; and
if all 3D formats in the plurality of 3D formats have been selected, identifying the received image as being in a two-dimensional (2D) format; and
if all 3D formats in the plurality of 3D formats have not been selected, selecting as a candidate 3D format a 3D format not previously selected from the plurality of 3D formats and repeating the generating and comparing steps using the not previously selected candidate 3D format; and
wherein, if the first and second sub-images are determined to be similar in structure;
determining an image difference between said first and second sub-images to generate an edge map having a plurality of edges;
computing a thickness for each edge in the plurality of edges;
wherein, if the thicknesses for the plurality of edges are uniformly distributed and less than or equal to a threshold, repeating said determining whether each 3D format of the plurality of 3D formats has been selected as a candidate 3D format; and
if all 3D formats in the plurality of 3D formats have not been selected, selecting as the candidate 3D format a 3D format not previously selected from the plurality of 3D formats and repeating the generating, determining an image difference and computing steps using the not previously selected 3D format;
wherein, if the thicknesses for the plurality of edges are not uniformly distributed or are greater than said threshold, identifying the received image as being formatted in a candidate 3D format used to make such determination.

10. The method as defined in claim 9 further comprising determining a distribution of thicknesses for the plurality of edges in said edge map and comparing the thickness of each edge to said threshold.

11. The method as defined in claim 9 wherein said plurality of 3D formats include blended 3D formats.

12. The method as defined in claim 9 wherein said plurality of 3D formats include non-blended 3D formats.

13. The method as defined in claim 9 wherein said plurality of 3D formats include blended 3D formats and non-blended 3D formats.

14. The method as defined in claim 9 wherein said computing to generate an edge map comprises computing a first image edge map of said first sub-image, computing a second image edge map of said second sub-image, and computing said image difference between said first image edge map and said second image edge map to generate said edge map having said plurality of edges.

15. The method as defined in claim 9 further including processing for display said received image according to the identified format.

16. The method as defined in claim 9 wherein said generating first and second sub-images further comprises filtering each of the first and second sub-images to be in a single channel of a plurality of channels so that said single channel of said first sub-image is identical to said single channel of said second sub-image.

17. The method as defined in claim 9 wherein said computing said image difference further includes removing each edge in said edge map whose thickness is less than a filtering threshold.

18. The method as defined in claim 17 wherein said removing includes one or more morphological filtering operations selected from the group of erosion, dilation, open and close operations.

19. The method as defined in claim 9 wherein said comparing said first and second sub-images to determine whether the first and second sub-images are similar with respect to structure comprises comparing at least one feature point in the first sub-image with at least a corresponding one feature point in the second sub-image.

20. The method as defined in claim 19 wherein said comparing said first and second sub-images to determine whether the first and second sub-images are similar with respect to structure further comprises detecting one or more features in each of said first and second sub-images.

21. The method as defined in claim 9 wherein said comparing said first and second sub-images to determine whether the first and second sub-images are similar with respect to structure further comprises evaluating a ratio of non-blank pixels in said edge map to a total number of pixels in said edge map as a measure of structure similarity.

22. An apparatus for identifying the presence of a three-dimensional (3D) image format in a received image, comprising:
means for generating first and second sub-images from the received image using a sampling method corresponding to a candidate 3D format selected from a plurality of 3D formats;
means for computing an image difference between the first and second sub-images to generate an edge map having a plurality of edges;
means for computing a thickness for each edge in the plurality of edges and if the thicknesses for the plurality of edges are uniformly distributed and less than or equal to a threshold, determining whether each 3D format of the plurality of 3D formats has been selected as a candidate 3D format;
wherein, if all 3D formats in the plurality of 3D formats have been selected, identifying the received image as a two-dimensional (2D) format; and
if all 3D formats in the plurality of 3D formats have not been selected, selecting as the candidate 3D format a 3D format not previously selected from the plurality of 3D formats and repeating the generating and computing steps using the not previously selected candidate 3D format; and
wherein, if the thicknesses for the plurality of edges are not uniformly distributed or are greater than said threshold, identifying the received image as being formatted in said candidate 3D format.

23. A computer-readable medium having computer-executable instructions for execution by a processing system, the computer-executable instructions for identifying the presence of a three-dimensional (3D) image format in a received image, when executed, cause the processing system to:
generate first and second sub-images from the received image using a sampling method corresponding to a candidate 3D format selected from a plurality of 3D formats;
compute an image difference between the first and second sub-images to generate an edge map having a plurality of edges; and
compute a thickness for each edge in the plurality of edges;
wherein, if the thicknesses for the plurality of edges are uniformly distributed and less than or equal to a threshold, determine whether each 3D format of the plurality of 3D formats has been selected as a candidate 3D format; and
if all 3D formats in the plurality of 3D formats have been selected, identify the received image as a two-dimensional (2D) format; and
if all 3D formats in the plurality of 3D formats have not been selected, select as the candidate 3D format a 3D format not previously selected from the plurality of 3D formats and repeat the generate and compute steps using the not previously selected 3D format; and
wherein, if the thicknesses for the plurality of edges are not uniformly distributed or are greater than said threshold, identify the received image as being formatted in a candidate 3D format used to make such determination.
